(19) United States
(12) Patent Application Publication
(10) Pub. No.: US 2004/0054881 A1
(43) Pub. Date: Mar. 18, 2004

(54) Level allocation

(76) Inventor: Mel Albert Gerard Long, Cambridge (GB)

Correspondence Address: BANNER & WITCOFF, LTD., TEN SOUTH WACKER DRIVE, SUITE 3000, CHICAGO, IL, 60606, US

(21) Appl. No.: 10/451,097

(22) PCT Filed: Dec. 18, 2001
(86) PCT No.: PCT/GB01/05552

(30) Foreign Application Priority Data
Dec. 18, 2000 (GB) 0030871.8

(51) Int. Cl. G06F 15/00

(52) U.S. Cl. 712/300

(57) ABSTRACT

A 3-bit value A1 A2 A3 is assigned to each bit B0 B2 B3 of a binary datastream to be transmitted. Each of the resulting 4-bit words is then converted to an analogue value to compose an analogue signal which is transmitted.

The invention relates to signal processing. In particular, the invention relates to ascribing levels to bits of binary information.

According to one aspect, the invention provides a method of producing a communications signal from a stream of binary bits to be transmitted, comprising, for each bit, allocating a level to the bit by attaching to the bit a number of bits describing an assigned level.

According to a second, and related aspect, the invention also provides apparatus for producing a communications signal from a stream of binary bits to be transmitted, comprising allocating, to each bit, a number of bits describing a level assigned to the bit.

Advantageously, the invention allows levels to be assigned to the bits of a binary datastream just prior to transmission from a transmitter. This means that the assignment of levels to the bits can be deferred to a late stage in the digital processing of the binary datastream, thus facilitating the upstream manipulation of the bitstream.

The invention also extends to the transmission of a stream of binary bits, by producing a communications signal representing the stream in the manner described above, converting the communications signal to the analogue domain treating each bit from the binary stream as a sign bit and its attached bits as denoting a magnitude, and transmitting the resulting analogue signal.

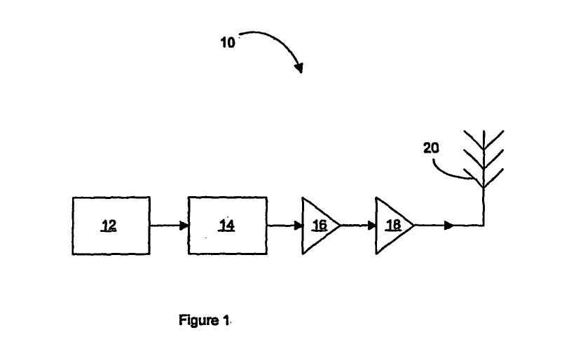

By way of example only, an embodiment of the invention will now be described by reference to FIG. 1, which illustrates a transmitter.

The transmitter 10 of FIG. 1 comprises a digital processing section 12 which produces a stream of bits S1 for transmission to a receiver. The stream S1 comprises a series of datawords, each several bits in length. The datawords represent, for example, a digitised and encoded speech signal that has been provided with error correcting information, etc.

The signal S1 is supplied to an allocator 14 which assigns a level to each of the bits in signal S1, as will now be described.

S1 can be regarded as a stream of bits B0, B1, B2, B3, B4 . . . Allocator 14 appends each of the bits of S1 with a 3-bit (in this example) binary number A1, A2, A3 which is assigned to the bit. Accordingly, allocator 14 outputs a signal which is a stream of 4-bit numbers, each 4-bit number comprising a bit from S1 with an allocated level of 3-bits, viz: B0 A1 A2 A3, B1 Al A2 A3, B2 A1 A2 A3, B3 A1 A2 A3 . . . Essentially, S1 has been converted into a “sign-magnitude” representation, wherein each bit of S1 becomes the “sign” bit of a word in S2.

Signal S2 is then passed to a digital to analogue converter (DAC) 16 which produces an analogue signal S3 by operating on each 4-bit word of S2 to determine the level of S3. The analogue signal S3 is then amplified at 18 and transmitted from antenna 20.

Within the allocator 14, the level or magnitude word A1 A2 A3 can be adjusted to change the amplitude or power present in signal S3.

To combine communications signals destined for transmission, other bit streams that have been converted into the sign-magnitude representation can be simply added into S2 prior to it being acted on by DAC 16.

1. A method of producing a communications signal from a stream of binary bits to be transmitted, comprising, for each bit, allocating a level to the bit by attaching to the bit a number of bits describing an assigned level.

2. A method according to claim 1, further comprising adjusting the attached bit or bits to adjust the level being allocated.

3. A method of transmitting a stream of binary bits, comprising producing a communications signal representing the binary stream by the method of claim 1 or 2, and converting the communications signal to the analogue domain for transmission by treating each bit of the binary stream as a sign bit and its attached bits as denoting a magnitude, and transmitting the resulting analogue signal.

4. Apparatus for producing a communication signal from a stream of binary bits to be transmitted, comprising allocating, to each bit, a number of bits describing a level assigned to the bit.

5. Apparatus according to claim 4, further comprising means for adjusting the attached bit or bits to adjust the level being allocated.

6. Apparatus for transmitting a stream of binary bits, comprising the apparatus of claim 4 or 5 for producing a communications signal from the binary stream and means for correcting the communications signal to the analogue domain for transmission by treating each bit of the binary stream as a sign bit and its attached bits as denoting a magnitude.

7. A method of producing a communications signal substantially as hereinbefore described with reference to the Figure.

8. A method of transmitting a stream of binary bits as a communications signal, substantially as hereinbefore described with reference to the Figure.

9. Apparatus for producing a communications signal, substantially as hereinbefore described with reference to the Figure.

10. Apparatus for transmitting a stream of binary bits as a communications signal, substantially as hereinbefore described with reference to the Figure.
